(19) United States
(12) Patent Application Publication
(10) Pub. No.: US 2026/0362270 A1
(43) Pub. Date: Nov. 12, 2026

(54) SYSTEMS AND METHODS FOR MANAGING NON-TERRESTRIAL AND SUPPLEMENTAL COVERAGE FROM SPACE RESOURCES FOR TARGETED TRAFFIC

(71) Applicant: AALYRIA TECHNOLOGIES, INC., LIVERMORE, CA (US)

(72) Inventors: STEFAN DRASKOCI, LONDON (GB); BRIAN BARRITT, PITTSBURGH, PA (US); LUCA LODIGIANI, LONDON (GB)

(21) Appl. No.: 19/666,219

(22) Filed: May 2, 2026

Related U.S. Application Data
(60) Provisional application No. 63/801,286, filed on May 7, 2025.
(60) Provisional application No. 63/886,464, filed on Sep. 23, 2025.

(51) Int. Cl. H04W 36/08

(52) U.S. Cl. CPC H04W 36/08

(57) ABSTRACT

The current disclosure utilizes a nonterrestrial network to provide network coverage to one or more network cells using a plurality of configurations. In an aspect of the present disclosure, the nonterrestrial network may utilize a platform that may switch between one or more user links or feeder links to provide network coverage for a single network cell or multiple network.

### CROSS REFERENCE TO RELATED APPLICATIONS

This U.S. Non-Provisional Application claims the benefit of priority to U.S. Provisional Application Number 63/886,464, filed Sep. 23, 2025; and also claims the benefit of priority to U.S. Provisional Application Number 63/801,286, filed May 7, 2025, the disclosures of which are incorporated by reference herein in their entirety.

### BACKGROUND

Gaps in connectivity may exist where the deployment of terrestrial base stations has proven to be physically infeasible or commercially unavailable. Proprietary satellite systems may be utilized to serve such remote regions, however, these have in most cases proven to be too inaccessible and impractical to the end user to see widespread adoption.

The 3GPP family of standards for mobile networks has achieved global adoption and usage and has given rise to billions of mobile devices which support a number of generations of the standard (3G, 4G, 5G, etc.). The combination of these standards with the ubiquitous reach of satellites presents a compelling solution to deliver connectivity to unconnected regions and people.

This opportunity was recognized in 3GPP and has been actively addressed in recent years as a new flavor of the 5G NR standard, called 5G Non-Terrestrial Networks (NTN). Non-Terrestrial Networks may utilize spaceborne (e.g., satellites), airborne (e.g., drones or balloons), or other non-ground-based platforms to act as a repeater of a 5G waveform which may be generated on the ground. In an example, Low Earth Orbit (LEO) satellite constellations may be the preferred mode of delivery (e.g., via earth-fixed cells or satellite-fixed cells). In this example, a 5G gNodeB Radio Access Network (RAN) stack may generate a downlink (DL) NR-Uu waveform that may be transmitted by a NTN gateway to the LEO satellite(s) via a feeder link, where the NR-Uu waveform may be repeated, typically on another frequency, and retransmitted down to a terrestrial mobile device, a user equipment (UE), on a service link. In contrast, an uplink NR-Uu waveform may follow a reverse path, being transmitted by the UE via the service link to the LEO satellite(s), where the signal is retransmitted via the feeder link down to the NTN gateway and 5G gNodeB RAN.

In some examples, the geographical area on the earth's surface where one or more satellites may provide network coverage may be referred to as an Earth-Fixed Cell (EFC). An EFC may remain stationary relative to the earth, even though the satellites providing coverages may be moving (e.g., as in LEO or medium earth orbit (MEO)). In some examples, a satellite may move out of range of a NTN gateway and into range of another gateway, which may necessitate a feeder link switch. A feeder link switch may enable the satellite to continue providing coverage for an EFC. As satellites move across a coverage area, a serving satellite switch may be required for a given EFC. Pre-Release 17 systems may not have the mechanisms to handle timing, synchronization, or authentication that may be necessary for such feeder links or satellite switches. In an example, these mechanisms may be necessary due to timing across satellites or feeders being different due to different slant ranges.

In some examples, RAN components may be proprietary or tightly integrated by a single vendor. In other examples, such as an Open Radio Access Network (O-RAN), the RAN may be split into modular components that may come from different vendors. The O-RAN may include a radio unit to handle radio frequency transmissions and reception. The O-RAN may further include a distributed unit to process real-time data like scheduling or beamforming. The O-RAN may further include a central unit and RAN Intelligent Controller (RIC). In some examples, the RIC may include a Near-Real-Time (RT) RIC and/or a Non-RT RIC. In these examples, the Near-RT RIC may enable real-time control. The non-RT RIC may enable long-term optimization or policy management. The use of open interfaces may enable the equipment from different vendors to work together.

Subsequent releases of 3GPP may tackle the complexities of hosting a 5G gNodeB onboard satellites and have the capability to route traffic flows over Inter-Satellite Links (ISLs) to other satellites. These kinds of networks may offer greater flexibility to the end-to-end delivery of connectivity, but in doing so they may also increase operational complexity. Over time, Direct-to-Device 5G NTN services will evolve towards being capable of delivering higher data rates to the UE(s) to support different services.

The market is trending towards 5G NTN constellations being owned and operated by incumbent and emerging Satellite Network Operators (SNOs), who are distinct to the terrestrial Mobile Network Operators (MNOs) whose coverage gaps they are filling. Supplemental Coverage from Space (SCS) may provide an example in which SNO coverage may fill coverage gaps in the MNO coverage. Each independent 5G NTN constellation is intended to act as a logical extension of a number of 5G terrestrial networks all over the world, where the mobile devices are expected to roam onto the former in the absence of the latter. The end goal is to enable mobile users to consume connectivity services with minimal impact on their perceived experience, including seamless transitions/handovers between 5G Terrestrial Networks (TNs) and 5G NTNs. A key challenge in achieving this end goal is that the current 3GPP standards do not sufficiently address the architectural implementations and processes by which 5G TNs and NTNs will integrate and coordinate at the RAN and Core levels, to allow mobile devices (UEs) to be seamlessly handed over from one to the other.

Terrestrial network coverage gaps are in some cases quite wide, while in other cases significantly smaller. A UE driving on a highway might leave, re-enter, and again leave the terrestrial coverage area every couple of minutes. In order to assure seamless consumption of connectivity services, the network should be capable of maintaining voice and data-based conversations (e.g., WhatsApp) during the handovers between the TN and the NTN. In handover events between terrestrial base stations, this is achieved either by having an interface between the two gNodeBs which allows them to coordinate (e.g., the Xn interface), or by having them do so via their common Core Network (e.g., via the Next Generation (NG) interface). The establishment of this kind of interfacing on a global scale between the SNOs and various MNOs would be very difficult to achieve. As such, another key challenge is that current 3GPP standards for 5G NTN account for traditional mobile roaming between operators as being the handover procedure for transitions between the two, which would pose a significant interruption for a user to their consumption of connectivity services.

There are new NTN control plane signaling measures that were introduced by 3GPP to aid UEs for the initial access and mobility procedures, such as the System Information Block 19 (SIB19). These are intended to be unicast or broadcast by the TN RAN to UEs which are soon to be connected to the NTN network. The UEs use this information about their target satellite to properly synchronize in time and frequency with the NTN segment, to facilitate TN-to-NTN handover. In integrated TN and NTN environments, maintaining seamless coverages is challenged by dynamic conditions that may introduce or exacerbate coverage gaps within or between the two domains. Factors such as atmospheric interference, terrain obstructions, and satellite beam transitions can disrupt connectivity. These disruptions may necessitate mechanisms for proactive planning and real-time awareness to ensure continuity in network coverage. These mechanisms may include systems or methods to anticipate, detect, or respond to coverage gaps between TN and NTN, including SCS, to maintain reliable communication across diverse contexts.

### SUMMARY

The current disclosure may utilize an NTN to provide coverage to one or more network cells while switching one or more platforms on one or more feeder links or one or more user links with an unchanged physical cell identifier of the one or more network cells. In another example, the present disclosure may enable switching one or more satellites to cover the one or more network cells

In an aspect, a method is provided for satellite and feeder link switching without changing a cell identifier. The method may include the steps of: (A) detecting a first and second communication link vector; (B) deploying a first communications link to deliver telecommunication coverage to a first network cell; (C) deploying a first platform to provide network coverage to the first network cell; (D) determining a measurement timing configuration; (E) applying the measurement timing configuration to the first network cell; (F) detecting a user equipment that is approaching an edge of the first network cell; (G) in accordance with a determination that the user equipment will be handed over from the first network cell to a second network cell different from the first network cell, in accordance with a determination that the second network cell is being illuminated by the first platform, in accordance with a determination of a first set of one or more criteria, initiating a handover of the user equipment from the first network cell to the second network cell; and in accordance with a determination of a second set of one or more criteria: switching the first platform to a second communication link different from the first communication link; deploying the first platform to provide network coverage of the second network cell via the second communication link; and initiating a handover of the user equipment from the first network cell to the second network cell; (H) in accordance with a determination that the second network cell is illuminated by a second platform different from the first platform; deploying a third communication link different from the first communication link to deliver telecommunication network coverage to the second network cell; providing network coverage to the second network cell via the second communication link; and initiating a handover from the first network cell to the second network cell; and (I) in accordance with a determination that the user equipment will not be handed over from the first network cell to the second network cell, maintaining coverage of the first network cell via the first platform.

In an example, after determining that the user equipment will be handed over to a second network cell and in accordance with a determination of a first set of one or more criteria, initiating a handover of the user equipment from the first network cell to the second network cell. In another example, after a determination of a second set of one or more criteria: switching the first platform to a second communication link; deploying the first platform to provide network coverage of the second network cell; and initiating a handover of the user equipment from the first network cell to the second network cell.

In yet another example, in accordance with a determination that the second network cell is illuminated by a second platform; deploying a third communication link; providing network coverage to the second network cell via the second communication link; and initiating a handover from the first network cell to the second network cell.

In yet another example aspect, in accordance with a determination that the user equipment will not be handed over from the first network cell to the second network cell, maintaining coverage of the first network cell via the first platform.

### DESCRIPTION OF THE DRAWINGS

FIG. 1A illustrates a diagram of an example NTN providing telecommunication network coverage for one or more earth fixed cells in accordance with an example of the present disclosure.

FIG. 1B illustrates a diagram of an example NTN providing telecommunications network coverage for one or more earth fixed cells in accordance with an example of the present disclosure.

FIG. 2 is a diagram of an example NTN providing telecommunications network coverage for one or more earth fixed cells in accordance with an example of the present disclosure.

FIG. 3 is a diagram of an example NTN that may include one or more network cells in accordance with an example of the present disclosure.

FIG. 4 is a diagram of an example NTN in accordance with an example of the present disclosure.

FIG. 5 is a diagram of an example NTN in accordance with an example of the present disclosure.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

In an NTN, one or more satellites may be utilized to provide telecommunications network coverage for one or more EFCs. As the one or more satellites move through space, to support continuous telecommunications coverage for one or more EFCs, the one or more satellites may need to switch feeder links from time to time. In some examples, as satellites move across a given coverage area, it may be necessary to switch from a satellite serving the one or more EFCs to another satellite (e.g., a change of satellites) to maintain continuous coverage for the one or more EFCs. 3GPP Release 17 includes enhancements to 5G systems, including improvements in radio access technologies, network slicing, and non-terrestrial networks. Pre-Release 17 networks may not have native mechanisms to deal with feeder link switches or serving satellite switches.

The disclosed subject matter may include a method to maintain continuous network coverage for one or more EFCs with one or more satellites while mitigating impacts from motion or orbital patterns of the one or more satellites. In an example aspect, the method may include switching between feeder links, and/or an associated gateway, to enable a given satellite to maintain coverage over a given set of EFCs. In another example aspect, the method may include switching between multiple satellites to maintain coverage over a given set of EFCs. The disclosed subject matter may provide the network support in a number of ways including feeder link or gateway management; inter-satellite mobility or switching for EFCs; or UE mobility.

In another example aspect, the disclosed subject matter may enable feeder link or satellite switching with an unchanged physical cell identity in pre-release 17 networks. In an example, the disclosed subject matter may enable feeder link or gateway management by advancing cell timing. The disclosed subject matter may further enable frame management or synchronization. A variable timing advance may be applied to or maintained at a base station. In an example, the base station may be an Evolved Node B used in 4G Long-Term Evolution (LTE) networks. In another example, the base station may be a Next Generation Node B used in 5G New Radio (NR) networks.

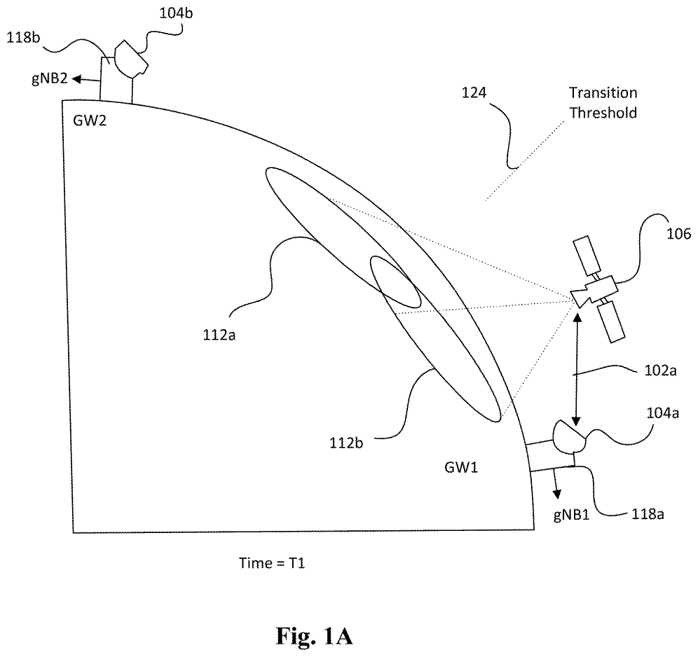

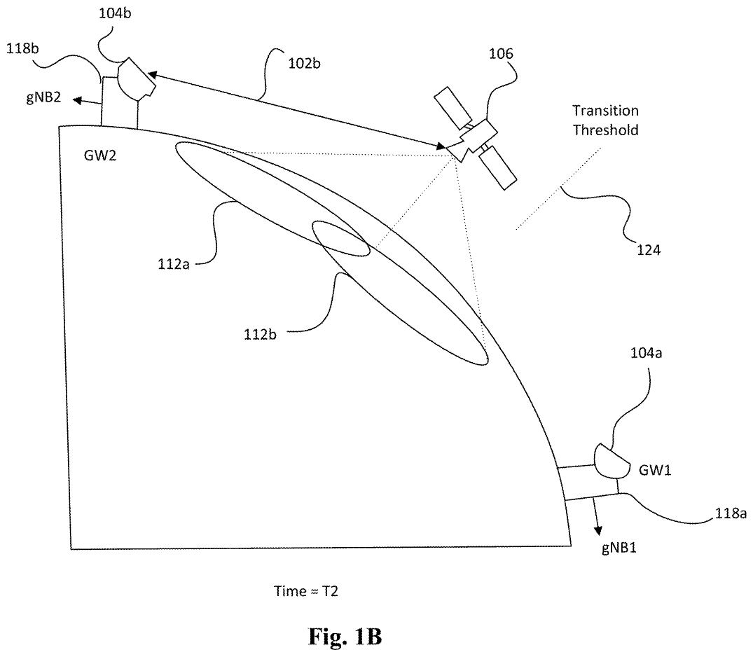

FIGS. 1A and 1B illustrate an example NTN providing telecommunications network coverage for one or more earth-fixed cells. As illustrated in FIGS. 1A and 1B, platform 106 may be a part of an NTN providing network coverage for cell 112a and 112b. In some examples, the NTN may be a supplemental coverage from space (SCS) network. In some examples, cell 112a and cell 112b may be stationary on the Earth's surface. For example, platform 106 may be a satellite in a constellation of satellites that make up the NTN. In other examples, the NTN may utilize one or more airborne platforms to provide network coverage. For example, platform 106 may be a high-altitude platform station (HAPS) in a fleet of HAPS. For another example, platform 106 may be an unmanned aerial vehicle (UAV) in a fleet of unmanned aerial vehicles. For yet another example, platform 106 may be a HAPS or UAV in a mixed fleet of HAPS, UAVs, satellites, and/or manned aerial vehicles. At FIGS. 1A and 1B, cell 112a and/or cell 112b may provide one or more network services (e.g., cellular phone coverage, messaging services, or internet access) for one or more user devices within cell 112a and/or cell 112b.

As illustrated in FIGS. 1A and 1B, the NTN may include station 118a and station 118b. At FIGS. 1A and 1B, station 118a and 118b, may handle one or more first functions of a gNodeB (gNB). In some examples, the gNB may include multiple parts. For example, the gNB may include a radio unit (RU), which may handle transmissions and/or reception; a distributed unit (DU), which may handle real-time layer 1 and/or layer 2 functions; and/or centralized unit (CU), which may handle higher-layer function (e.g., mobility and session management). In some examples, station 118a and/or station 118b may handle a portion of the gNB functions while platform 106 handles a different portion of the gNB functions. For example, platform 106 may host the RU while station 118a and/or station 118b hosts the DU and CU. As illustrated in FIGS. 1A and 1B, station 118a and station 118b are located at gateway 104a and gateway 104b, respectively. As illustrated in FIGS. 1A and 1B, platform 106 may connect to gateway 104a or gateway 104b via a feeder link (e.g., feeder link 102a or feeder link 102b). At FIGS. 1A and 1B, gateway 104a and gateway 104b may enable access to core network functions (e.g., internet services, messaging, and/or calls) to the gNB (e.g., station 118a or 118b, and platform 106), thereby enabling the gNB to connect one or more user devices to the core network functions.

At FIGS. 1A and 1B, platform 106 may be in non-geostationary orbit and may traverse a trajectory relative to the Earth's surface. At FIGS. 1A and 1B, platform 106 may connect to a station (e.g., station 118a or station 118b) and/or gateway (e.g., gateway 104a or gateway 104b) based on the location of platform 106 in relation to threshold 124. In some examples, threshold 124 may represent a location that may be used to determine when platform 106 may switch from a station and/or gateway to another. In this way, platform 106 may maintain continuous network coverage for cell 112a and 112b while traversing through its orbital pattern.

As illustrated in FIG. 1A, platform 106 is displayed at a first position at a first time (e.g., Time=T1). At FIG. 1A, platform 106 may be linked to gateway 104a via feeder link 102a. As illustrated in FIG. 1A, station 118a may be located at gateway 104a. In this way, platform 106 and station 118a may provide all functions of a gNB and may utilize gateway 104a to access one or more core network functions. At FIG. 1A, satellite 106 may provide coverage for one or more user devices within the coverages of cells 112a and 112b. At FIG. 1A, satellite 106 may be in motion along its orbital track from right to left.

As illustrated in FIG. 1B, platform 106 may have moved along its orbital track (e.g., from right to left) and is displayed at a second position at a second time (e.g., Time=T2).

At FIG. 1B in response to platform 106 crossing threshold 124, platform 106 may switch from link 102a to link 102b to connect to gateway 104b. In some examples, when connecting to gateway 104b, platform 106 may connect to station 118b to ensure platform 106 and station 118b together may perform the functions of a gNB (e.g., the RU, DU, and/or CU). As illustrated in FIG. 1B, the slant range from platform 106 to gateway 104a may be different from the slant range from the platform 106 to gateway 104b. For example, the slant range from platform 106 to gateway 104a at the first time (T1) may be shorter than the slant range from platform 106 to gateway 104b at the second time (T2). The difference in slant range may cause a difference in timing from platform 106 across the feeder links to a gateway (e.g., the time for a signal to reach platform 106 from gateway 104a or vice versa may be dependent on the distance between platform 106 and gateway 104a). At FIG. 1B, after switching platform 106 to link 102b, a combination of feeder and user link vectors may be employed to deliver coverage to cell 112a and 112b. In some examples, the combination of feeder link and user link vectors may define a variable timing advance that may be applied and maintained at station 118b. At FIG. 1B, the variable timing advance may be applied during the coverage of network cell 112a and 112b by platform 106 to maintain synchronization with one or more UEs that may be covered by network cell 112a and 112b.

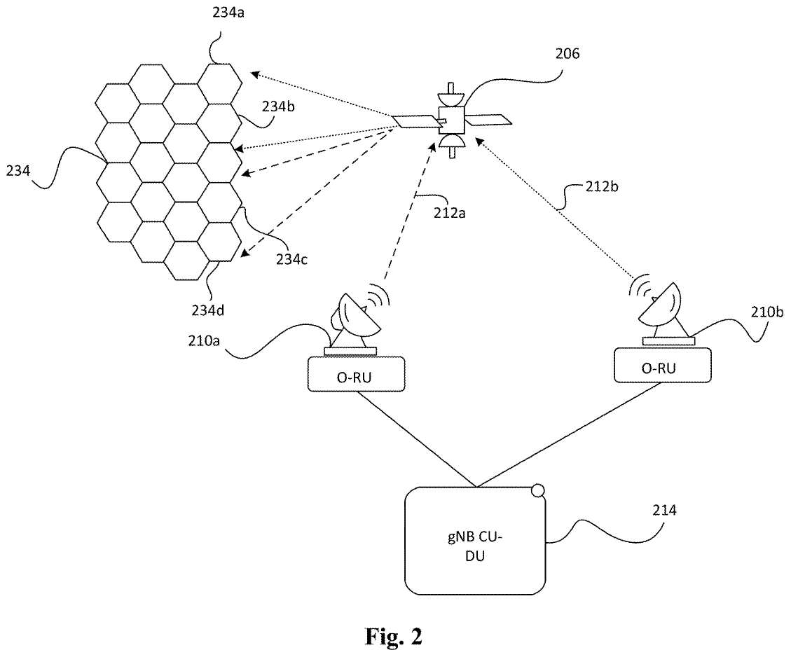

FIG. 2 illustrates an example NTN providing telecommunications network coverage for one or more earth fixed cells. As illustrated in FIG. 2, the NTN may include platform 206. Platform 206 may perform similar functions to platform 106 as described herein. In some examples, the NTN may be an SCS network. In some examples, the NTN may utilize one or more airborne platforms for network coverage. For example, platform 206 may be one or more satellites, one or more HAPS, one or more UAVs, and/or one or more manned aerial vehicles. At FIG. 2, platform 206 may provide coverage for mosaic 234. Mosaic 234 may be a group of multiple network cells. As illustrated in FIG. 2, mosaic 234 may include network cell 234a-234d. At FIG. 2, platform 206 may provide coverage for one or more network cells in mosaic 234. For example, platform 206 may provide coverage for network cell 234a. For another example, platform 206 may provide coverage for network cell 234c and 234d. For yet another example, platform 206 may provide coverage for all of mosaic 234. At FIG. 2, mosaic 234 may perform similarly to cell 112a and/or cell 112b.

As illustrated in FIG. 2, the NTN may include stations 210a and 210b. At FIG. 2, stations 210a and 210b may perform similar functions to stations 118a and 118b as described herein. In some examples, stations 210a and/or 210b may perform one or more functions associated with a radio unit component of the network. In some examples, station 210a and/or 210b may be an open radio unit (O-RU) as a part of an open RAN. As illustrated in FIG. 2, the NTN may further include gateway 214. At FIG. 2, gateway 214 may serve as an interface between a fronthaul network in the NTN and a shared resource pool of central units and/or distributed units. In some examples, gateway 214 may be part of a gNB. In some examples, gateway 214 may act as the gNB.

At FIG. 2, platform 206 may link to station 210a via link 212a and station 210b via link 212b. At FIG. 2, a first network signal provided by gateway 214 via station 210a, link 212a, and platform 206 may provide network coverage for network cell 234c and 234d. At FIG. 2, a second network signal provided by gateway 214 via station 210b, link 212b, and platform 206 may provide network coverage for network cell 234a and 234b. At FIG. 2, the first network signal may experience a first delay in timing for the signal to reach network cell 234c and 234d. The second network signal may experience a second delay in timing for the signal to reach network cell 234a and 234b. At FIG. 2, the first delay in timing may be shorter than the second delay in timing. Based on a determination of a set of one or more criteria, gateway 214 may cease using station 210b to provide a network signal to network cell 234a and 234b. After gateway 214 has ceased using station 210b to provide the network signal, and while providing network coverage for network cell 234c and 234d, gateway 214 may utilize station 210a to provide network coverage to network cell 234a and 234b via link 212a and platform 206. In some examples the set of one or more criteria may include a determination that a location of platform 206 may make link 212b. In some examples, the set of one or more criteria may include a comparison of the first delay in timing and the second delay in timing.

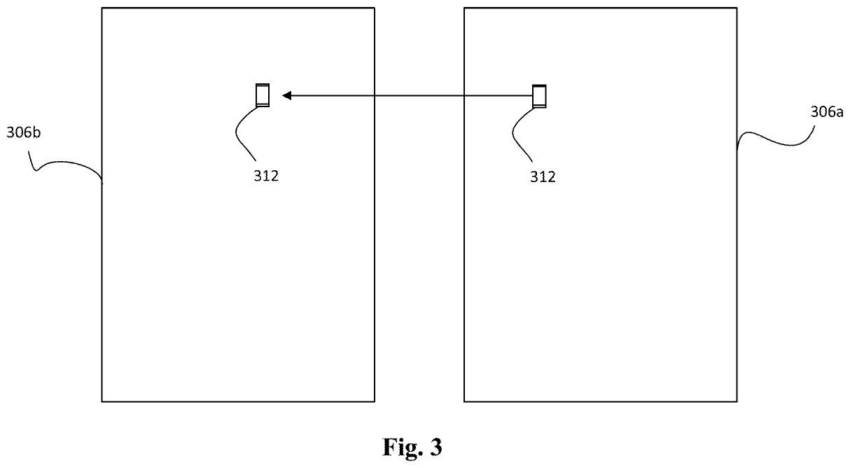

FIG. 3 is an illustration of a network that may include one or more network cells. As illustrated in FIG. 3, the network may include network cell 306a and 306b, which are shown as rectangles but could be formed of any shape. At FIG. 3, network cell 306a and 306b may perform similarly to cell 112a and 112b as described herein. In some examples, network cell 306a and 306b may each have a physical cell identity. At FIG. 3, network cell 306a and 306b may be used to provide network coverage for UE 312. It should be recognized that network cell 306a and 306b may provide coverage for more UEs than UE 312. For example, network cell 306a and 306b may provide network coverage for three UEs. At FIG. 3, an NTN may provide coverage for network cell 306a and 306b. At FIG. 3, UE 312 may be linked to one or more platforms in the NTN via one or more user links.

At FIG. 3, UE 312 is in a first position at a first time. The first position corresponds to a geographical area corresponding to network cell 306a. At FIG. 3, network cell 306a may provide network coverage for UE 312 at the first position. At FIG. 3, UE 312 may transit from the first position to a second position at a second time. At FIG. 3, the second position may be located in an area corresponding to network cell 306b. At FIG. 3, in response to detecting UE 312 moving from network cell 306a towards network cell 306b and in accordance with a determination that UE 312 approaching the edge of network cell 306a, the network may trigger a handover of UE 312 from network cell 306a to network cell 306b. In some examples, the NTN may use a first platform to provide coverage to network cell 306a via a first user link and a second platform to provide coverage to network cell 306b via a second user link. In this example, the handover may include switching UE 312 from the first platform and first user link to the second platform via the second user link in order to enable UE 312 to have network coverage in network cell 312. In other examples, the first platform may provide coverage for network cell 306a and 306b. In these examples, the network may utilize the first user link to maintain coverage for UE 312 as UE 312 transits from network cell 306a to network cell 306b.

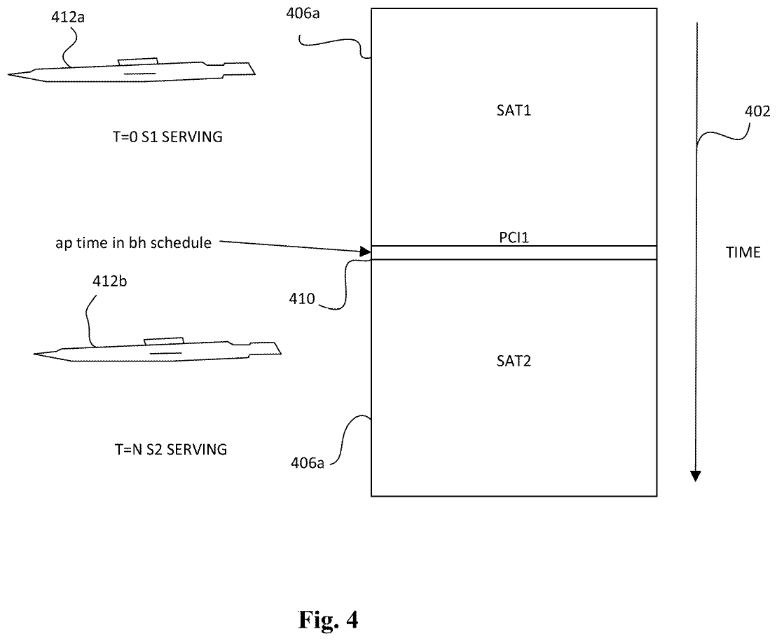

FIG. 4 illustrates an example NTN. As illustrated in FIG. 4, the NTN may include platforms 412a and 412b. As illustrated in FIG. 4, the NTN may further include network cell 406a, which is again shown as a rectangular shape but could be any shape. At FIG. 4, the NTN may utilize platforms 412a or 412b to provide network coverage for network cell 406a. At FIG. 4, platforms 412a and 412b may perform similarly to platform 106 as described herein. The NTN in FIG. 4 may perform similarly to the NTN of FIGS. 1A, 1B, 2, and 3, as described herein. At FIG. 4, platform 412a may provide coverage for network cell 406a at a first time. At FIG. 4, the NTN may switch network cell 406a from platform 412a to platform 412b with minimal impact to one or more UEs that may be covered by network cell 406a. At FIG. 4, the NTN may provide one or more network-requested signal measurements and apply a cell-level or UE-level SMTC configuration to platform 412b. At FIG. 4, platform 412b may provide coverage to network cell 406a at a second time. At FIG. 4, a gap time 410 to perform the switch from platform 412a to platform 412b may be done within a cyclic prefix timing, thereby minimizing impacts to the one or more UEs.

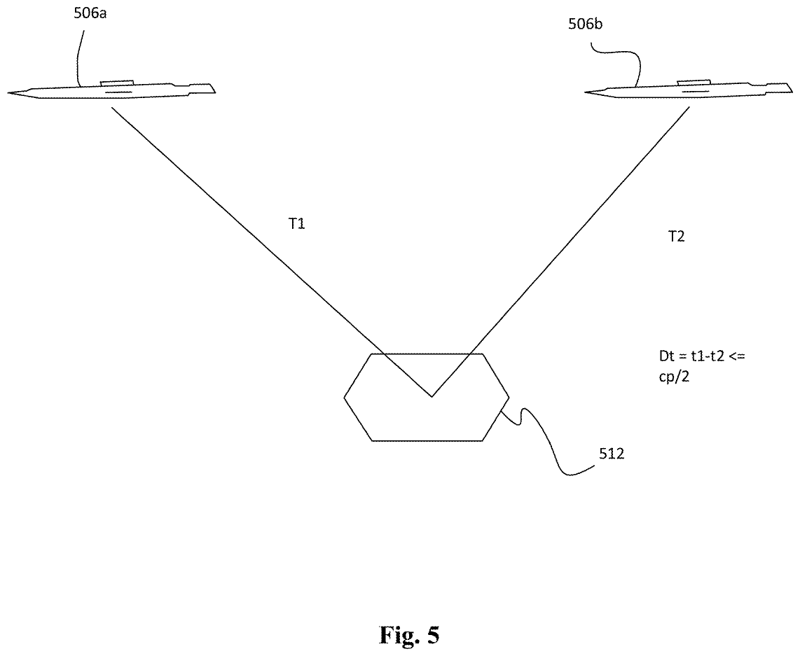

FIG. 5 illustrates an example NTN. As illustrated in FIG. 5, the NTN may include platform 506a, platform 506b, and network cell 512. At FIG. 5, the NTN may perform similarly to the NTN in FIG. 4 as described herein. Platforms 506a and/or platform 506b may perform similarly to platform 106, as described herein. Network cell 512 may perform similarly to cells 112a and/or 112b as described herein. At FIG. 5, platform 506a may provide coverage for network cell 512 at a first time. At FIG. 5, the NTN may switch from platform 506a to platform 506b to enable platform 506b to provide coverage for network cell 512. At FIG. 5 a cyclic prefix may be determined based on a difference in time between the second time and the first time. In this way, the NTN may account for one or more criteria to perform the switch from platform 506a to platform 506b within the cyclic prefix timing.

In an example of the disclosed subject matter, the NTN may utilize a network controller to manage one or more feeder link switches or one or more satellite switches. To provide continuous coverage during or after a change of base stations, may require a change in feeder link or user link vectors. The feeder link or user link vectors may include directional or signal characteristics of the communication paths between different parts of the satellite system. In an example, the feeder link vector may refer to a directional vector or signal path characteristics (e.g., angle, polarization, frequency, or power) of the signal transmitted between the ground station and the satellite. In another example, the user link vector may refer to the directional or signal parameters of the transmission between the satellite and a user terminal (e.g. user equipment). The combination of feeder and user link vectors to be employed to deliver coverage to a cell may define the variable timing advance.

In an example, the network may be pre-compensated, enabling switching a cell between two feeder links, or two satellites, with minimal impact to the UE. In some examples, the switching may be kept within a Cyclic prefix timing, further minimizing the impact to the UE. In these examples, feeder link or satellite switching may be treated as special cases of beam hopping.

The appropriate timing advance may be applied or varied during a satellite pass to maintain synchronization with UEs in the cell. In some examples, the timing advance may be applied or varied via a service-based interface (SBI) to a business process management system (BPMS). The disclosed method may then include power control or re-configuration of the feeder link or gateway.

The disclosed subject matter may further include inter-satellite mobility or switching for EFCs. The network controller may determine a cell or UE-level synchronization signal/physical broadcast channel block measurement timing configuration (SMTC). The network controller may further apply the appropriate cell or UE-level SMTC to facilitate the handover or provide network requested signal measurements. In an example, the physical cell identity (PCI) may be unchanged. In this way, a given cell may be provided with network coverage through a change of serving satellites. In another example, the network controller may perform a dual PCI, handover or conditional handover at the physical layer (L1).

The disclosed subject matter may further enable UE mobility across network cells. In some examples, UE mobility may be facilitated by an intra-satellite handover or conditional handover. For example, the intra-satellite handover may be network controlled, the handover decision may be made by the source base station (e.g., gNB), and the UE may detach from a first cell and connect to a second cell with coverage provided by a first satellite that may provide coverage to the first and second cell. In other examples, UE mobility may be facilitated by an inter-satellite handover or conditional handover. For example, the UE may detach from a first cell and connect to a second cell with coverage provided to the first cell by a first satellite and coverage provided to the second cell by a second satellite. In these examples, in response to detecting that the UE is approaching the edge of its current serving cell, the network controller may initiate a handover of the UE to a different cell that is illuminated by the same or a different satellite. In another example, the disclosed subject matter may enable lower-layer triggered mobility (LTM). For example, the disclosed subject matter may initiate mobility procedures at the L1 and/or data link layer L2).

1. A method for satellite and feeder link switching without changing a cell identifier, the method comprising:
detecting a first communication link vector and a second communication link vector different from the first communication link vector;
after detecting the first communication link vector and the second communication link vector, deploying a first communication link to deliver telecommunication network coverage to a first network cell, wherein the first communication link comprises a combination of one or more user links and one or more feeder links, wherein the first network cell provides telecommunication network coverage for one or more user equipment;
deploying a first platform to provide network coverage to the first network cell via the first communication link;
after deploying the first platform to provide network coverage to the first network cell via the first communication link and after a determination of a measurement timing configuration, applying the measurement timing configuration at the first network cell;
detecting a user equipment that is exiting the first network cell to enter a second network cell different from the first network cell, wherein the first platform provides network coverage for the second network cell via the first communication link; and
initiating a handover of network coverage of the user equipment by the first network cell to the second network cell.

2. The method of claim 1, further comprising:
ceasing provision of network coverage for the second network cell by the first platform;
deploying a second communication link different from the first communications link to deliver telecommunication network coverage to the second network cell; and
after deploying the second communication link to provide network coverage for the second network cell, deploying a second platform different from the first platform to provide network coverage for the second network cell via the second communication link.

3. The method of claim 2, wherein the first platform and second platform comprise one or more satellites.

4. The method of claim 1, wherein the first communication link vector and the second communication link vector define a variable timing advance that is applied and maintained at one or more base stations.

5. The method of claim 4, wherein the one or more base stations comprise one or more evolved Node Bs and one or more next-generation Node Bs.

6. The method of claim 1, wherein the first communication link vector and the second communication link vector comprise one or more directional paths and trajectories that one or more feeder links and one or more user links follow between a ground station and a satellite, 7. The method of claim 1, wherein the measurement timing configuration comprises a measurement timing configuration of the first network cell and the one or more user equipment level measurement timing configurations.

8. The method of claim 1, further comprising applying the measurement timing configuration at a user equipment level.

9. A method for satellite and feeder link switching without changing a cell identifier, the method comprising:
deploying a first platform to provide telecommunication coverage to one or more network cells via a first feeder link from a first station at a first gateway, the one or more network cells providing telecommunication coverage to one or more user equipment within the one or more network cells via one or more user links;
when a first set of one or more criteria is satisfied:
while providing telecommunication coverage to the one or more network cells, switching the first platform to a second feeder link from a second station, wherein the second station is different from the first station; and
providing telecommunication coverage, using the first platform, to the one or more network cells via the second feeder link.

10. The method of claim 9, further comprising when a second set of one or more criteria is satisfied:
ceasing deployment of the first platform to provide telecommunication coverage to the one or more network cells; and
after ceasing deployment of the first platform to provide telecommunication coverage to the one or more network cells, deploying a second platform, different from the first platform, to the one or more network cells via the first feeder link, wherein the time between ceasing deployment of the first platform and deploying the second platform comprises a programmed time.

11. The method of claim 10, wherein the programmed time is a cyclic prefix time.

12. The method of claim 9, wherein the second station is also at the first gateway.

13. The method of claim 9, wherein the second station is at a second gateway different from the first gateway.
